(19) United States
(12) Patent Application Publication
(10) Pub. No.: US 2014/0358517 A1
(43) Pub. Date: Dec. 4, 2014

(54) METHOD FOR PROVIDING TEXT CONVERSION SERVICE AND ELECTRONIC DEVICE THEREOF

(71) Applicant: SAMSUNG ELECTRONICS CO., LTD., Suwon-si (KR)

(72) Inventors: Yeong-Seong YOUN, Seoul (KR); Jin-Goo LEE, Seoul (KR); Woo-Suk CHOI, Seoul (KR); Seung-Hoon HAN, Suwon-si (KR); Ji-Yeon HAN, Busan (KR)

(73) Assignee: SAMSUNG ELECTRONICS CO., LTD., Suwon-si (KR)

(21) Appl. No.: 14/294,708

(22) Filed: Jun. 3, 2014

(30) Foreign Application Priority Data
Jun. 3, 2013 (KR) 10-2013-0063753

(51) Int. Cl. G06F 17/28

(52) U.S. Cl. CPC G06F 17/289
USPC 704/2

(57) ABSTRACT

A device and a method for providing a text conversion service in an electronic device are provided. The method of operating an electronic device includes displaying a screen including at least one display area, determining at least one of the at least one display area as a conversion area, acquiring a first text included in the conversion area, and providing a second text corresponding to the first text.

### CROSS-REFERENCE TO RELATED APPLICATION(S)

This application claims the benefit under 35 U.S.C. §119(a) of a Korean patent application filed on Jun. 3, 2013 in the Korean Intellectual Property Office and assigned Serial number 10-2013-0063753, the entire disclosure of which is hereby incorporated by reference.

### TECHNICAL FIELD

The present disclosure relates to a method for providing text conversion service and an electronic device thereof.

### BACKGROUND

With the development of information and communication technology and semiconductor technology, various electronic devices have been developed into a multimedia device that provides various multimedia services. For example, a portable electronic device may provide various multimedia services such as a broadcasting service, a wireless Internet service, a camera service, or a music reproduction service.

The electronic devices may provide a translation service of a sentence input by a user by executing a translation application program for user convenience.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for providing text conversion service and electronic device thereof.

When the translation service is provided, the electronic device may display translation information of a word or a sentence input by a user through a translation application program in an area separate from that of an original word or an original sentence. Accordingly, because the user of the electronic device can perform translation in a specific translation application program and should directly input a word or a sentence to translate, it may be inconvenient for the user to continuously perform a plurality of translation works.

In an embodiment of the present disclosure, a text included in a selected screen area can be translated based on a user input.

In an embodiment of the present disclosure, a translated text can be displayed in a screen area in which an original text has been displayed.

In an embodiment of the present disclosure, a device and method are provided for providing a text conversion service in an electronic device.

In an embodiment of the present disclosure, a device and method are provided for providing a text conversion service through middleware in an electronic device.

In an embodiment of the present disclosure, a device and method are provided for providing a text conversion service by extracting a text of a reference area in an electronic device.

In an embodiment of the present disclosure, a device and method are provided for determining a reference area for extracting a text based on a user input in an electronic device.

In an embodiment of the present disclosure, a device and method are provided for determining a reference area for extracting a text based on hovering information in an electronic device.

In an embodiment of the present disclosure, a device and method are provided for determining a text display area of a location in which hovering is detected to a reference area for extracting a text in an electronic device.

In an embodiment of the present disclosure, a device and method are provided for determining a reference area for extracting a text using paragraph information of a location in which hovering is detected in an electronic device.

In accordance with an aspect of the present disclosure, a method of operating an electronic device is provided. The method includes displaying a screen including at least one display area, determining at least one of the at least one display area as a conversion area, acquiring a first text included in the conversion area, and providing a second text corresponding to the first text.

In accordance with another aspect of the present disclosure, an electronic device is provided. The electronic device includes a display unit configured to display a screen including at least one display area, and a processor configured to control to determine at least one of at least one display area included in the screen as a conversion area, to acquire a first text included in the conversion area, and to provide a second text corresponding to the first text.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure;

FIG. 2 is a block diagram illustrating a configuration of a programming module according to an embodiment of the present disclosure;

FIG. 3 is a block diagram illustrating a configuration of a processor according to an embodiment of the present disclosure;

FIG. 4 is a block diagram illustrating a configuration of an electronic device according to an embodiment of the present disclosure;

FIG. 5 is a flowchart illustrating a process of providing a text conversion service in an electronic device according to an embodiment of the present disclosure;

FIG. 6 is a flowchart illustrating a process of providing a text conversion service in an electronic device according to an embodiment of the present disclosure;

FIG. 7 is a flowchart illustrating a process of providing a text conversion service in an electronic device according to an embodiment of the present disclosure;

FIG. 8 is a flowchart illustrating a process of providing a text conversion service using a server in an electronic according to an embodiment of the present disclosure;

FIG. 9 is a flowchart illustrating a process of providing a text conversion service using a server in an electronic device according to an embodiment of the present disclosure;

FIG. 10 is a flowchart illustrating a process of converting a text in a server according to an embodiment of the present disclosure;

FIG. 11 is a flowchart illustrating a process of extracting a text in an electronic device according to an embodiment of the present disclosure;

FIG. 12 is a flowchart illustrating a process of converting a display text of a conversion area in an electronic device according to an embodiment of the present disclosure; and

FIGS. 13A, 13B, 13C, 13D, 13E, and 13F are diagrams illustrating a screen configuration for a text conversion service according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter, various embodiments of the present disclosure describe technology to provide a text conversion service in an electronic device. Here, the text conversion service may include a translation service.

In an embodiment of the present disclosure, an electronic device may be at least one combination of various devices such as a smart phone, a tablet personal computer (PC), a mobile phone, an audiovisual phone, an e-book reader, a desktop PC, a laptop PC, a netbook computer, a personal digital assistant (PDA), a portable multimedia player (PMP), a moving picture experts group layer-3 (MP3) player, a mobile medical equipment, jewelry, an electronic accessory, a camera, a wearable device, an electronic clock, a wristwatch, a refrigerator, an air-conditioner, a cleaner, an artificial intelligence robot, a television, a digital video disk (DVD) player, an audio device, an oven, a microwave oven, a washing machine, an electronic bracelet, an electronic necklace, an air cleaner, an electronic frame, medical devices (e.g., a magnetic resonance angiography (MRA) device, a magnetic resonance imaging (MRI) device, a computed tomography (CT) device, a scanning machine, and a ultrasonic wave device), a navigation device, a global positioning system (GPS) receiver, an event data recorder (EDR), a flight data recorder (FDR), a set-top box, a television box (e.g., Samsung HomeSync™, Apple TV™, or Google TV™), an electronic dictionary, a vehicle infotainment device, an electronic equipment for ship (e.g., a navigation device and a gyro compass for a ship), avionics, a security device, electronic clothing, an electronic key, a camcorder, game consoles, a head-mounted display (HMD), a flat panel display device, an electronic album, a portion of furniture or a building/structure including an electronic device, an electronic board, an electronic signature input device, and a projector. The electronic device according to the present disclosure is not limited to the foregoing devices.

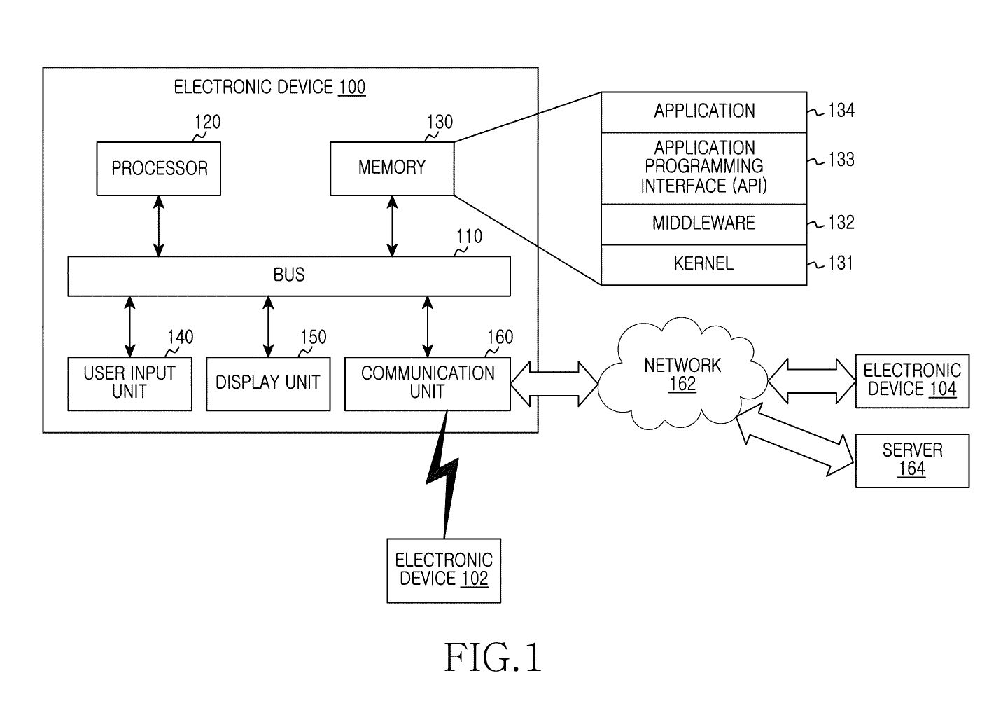

FIG. 1 is a block diagram illustrating a configuration of an electronic device according to an embodiment of the present disclosure.

Referring to FIG. 1, an electronic device 100 may include a bus 110, a processor 120, a memory 130, an input unit 140, a display unit 150, and a communication unit 160.

The bus 110 may connect constituent elements included in the electronic device 100 and control communication between constituent elements included in the electronic device 100.

The processor 120 may control the electronic device 100 to provide various services. For example, the processor 120 may decode an instruction received from at least one another constituent element (e.g., the memory 130, the input unit 140, the display unit 150, and the communication unit 160) included in the electronic device 100 through the bus 110 and execute a calculation or a data processing according to the decoded instruction.

By executing at least one program stored at the memory 130, the processor 120 may control the electronic device 100 to provide various multimedia services. For example, by executing a text conversion manager included in middleware 132 of the memory 130, the processor 120 may control to provide a text conversion service in a conversion area. Specifically, when the processor 120 detects that a text conversion event occurs, the processor 120 may determine a conversion area based on an area in which a user input is detected through the input unit 140. The processor 120 may control to extract a text included in the conversion area, to convert the extracted text with a specific language, and to convert and display the conversion area to another text. Here, the other text may be a text in which an original text of the conversion area is translated into another language.

The memory 130 may store an instruction or data received from at least one constituent element (e.g., the processor 120, the input unit 140, the display unit 150, and the communication unit 160) included in the electronic device 100 or generated by at least one constituent element. For example, the memory 130 may include programming modules such as a kernel 131, the middleware 132, an application programming interface (API) 133, and an application 134. Here, the programming module may include an operation system (OS) that controls a resource related to the electronic device 100 or various applications (e.g., the application 134) driven in the OS. In this case, each programming module may be formed with software, firmware, hardware, or at least two combinations thereof. The OS may include Android, iOS, Windows, Symbian, Tizen, Bada, or any other similar and/or suitable OS.

The kernel 131 may control or manage at least one system resource used for executing operation or a function implemented by another programming module (e.g., the middleware 132, the API 133, or the application 134) included in the memory 130. Further, the kernel 131 may provide an interface that accesses an individual element of the electronic device 100 in the middleware 132, the API 133, or the application 134 to control or manage the individual element. Here, the system resource may include the bus 110, the processor 120, the memory 130 or at least two thereof.

The middleware 132 may function as an intermediary that enables the API 133 or the application 134 to communicate with the kernel 131 to transmit and receive data. Further, the middleware 132 may perform a uniform resource distribution for a work request received from at least one application 134. For example, when at least one of a plurality of applications 134 uses a system resource of the electronic device 100, the middleware 132 may perform a uniform resource distribution for a work request such as a method of assigning a priority in which at least one application can use a system resource.

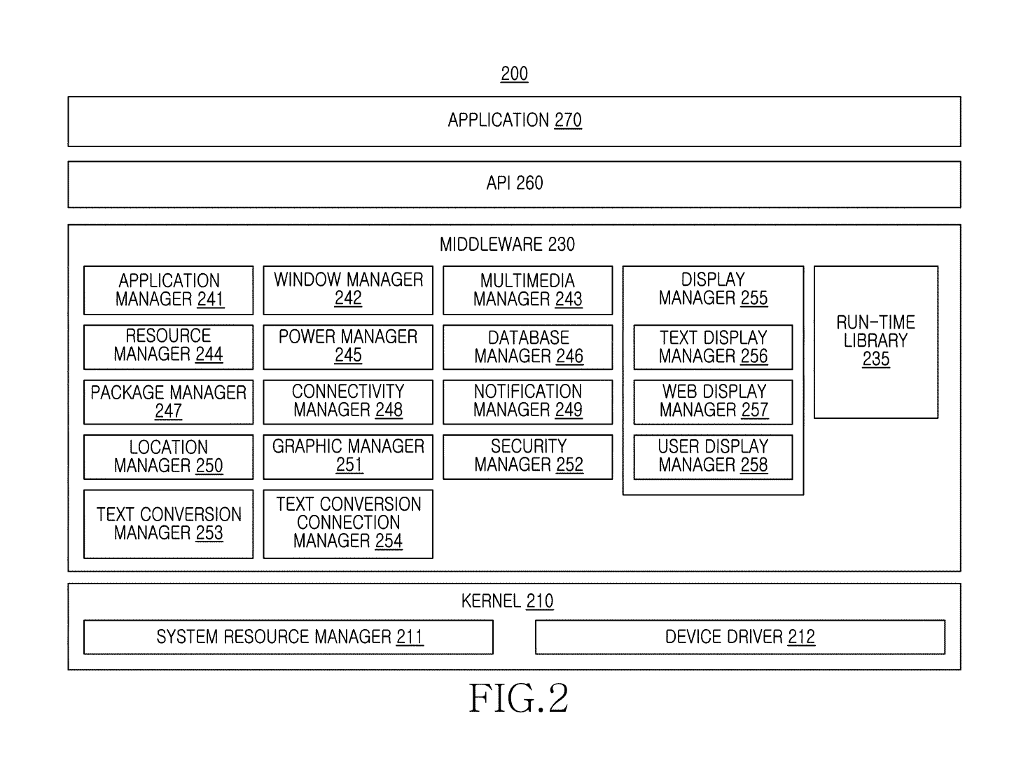

The middleware 132 may provide a function through the API 133 so that the application 134 may efficiently use a limited system resource within the electronic device 100. Further, in order to provide a function in which the application 134 commonly uses, the middleware 132 may include a previously implemented plurality of modules. For example, in order to provide a function in which the application 134 commonly uses, the middleware 132 may include a previously implemented plurality of modules, as shown in the following description. For example, the middleware 132 may include a text conversion connection manager 254 (FIG. 2) or a text conversion manager 253 (FIG. 2) for a text conversion service.

The API 133 may include an interface that can control a function in which the application 134 provides in the kernel 131 or the middleware 132. For example, the API 133 may include at least one interface or function such as file control, window control, image processing, or text control.

The input unit 140 may transmit an instruction or data occurring by a user selection to the processor 120 or the memory 130 through the bus 110.

The display unit 150 may display a picture, an image, or data.

The communication unit 160 may connect communication between at least one other electronic device 102 or 104 or a server 164 and the electronic device 100. For example, the communication unit 160 may support a short range communication protocol (e.g., wireless fidelity (Wi-Fi), bluetooth (BT), near field communication (NFC)) or communication of a network 162 (e.g., internet, a local area network (LAN), a wide area network (WAN), a telecommunication network, a cellular network, a satellite network, or plain old telephone service (POTS)). Here, another electronic device 102 or 104 may be a device of the same type as that of the electronic device 100 or may be a device of a type different from that of the electronic device 100.

FIG. 2 is a block diagram illustrating a configuration of a programming module according to an embodiment of the present disclosure.

Referring to FIG. 2, a programming module 200 may include kernel 210, middleware 230, an API 260, or an application 270. Here, each constituent element included in the programming module 200 may represent each constituent element included in the memory 130 of FIG. 1.

The kernel 210 may include a system resource manager 211 or a device driver 212.

The system resource manager 211 may perform operation such as a control, allocation, or recovery of a system resource. For example, the system resource manager 211 may include a process management unit, a memory management unit, or a file system management unit.

The device driver 212 may perform an operation to control a system resource used for executing operation or a function implemented by another constituent element (e.g., the middleware 230, the API 260, or the application 270) of the programming module 200. For example, the device driver 212 may include a display driver, a camera driver, a Bluetooth driver, a memory sharing driver, a universal serial bus (USB) driver, a keypad driver, a wireless LAN driver, an audio driver, or an inter-process communication (IPC) driver.

The middleware 230 may include at least one of a run-time library 235, an application manager 241, a window manager 242, a multimedia manager 243, a resource manager 244, a power manager 245, a database manager 246, a package manager 247, a connectivity manager 248, a notification manager 249, a location manager 250, a graphic manager 251, a security manager 252, a text conversion manager 253, a text conversion connection manager 254, and a display manager 255.

In order to add a new function through a programming language while the application 270 is being executed, the run-time library 235 may include a library module which a compiler uses. For example, the run-time library 235 may perform a function of an input and output, memory management, or arithmetic function.

The application manager 241 may manage a life cycle of at least one of applications 270.

The window manager 242 may manage a GUI resource that uses in the screen.

The multimedia manager 243 may determine a format used for reproduction of various media files and perform encoding or decoding of a media file using a coder and decoder (codec) corresponding to the format.

The resource manager 244 may manage a source code of at least one of the applications 270 and a resource of the memory 130 or storage space.

The power manager 245 may manage a battery or power by operating together with a basic input output system (BIOS).

The database manager 246 may manage to generate, search for, or convert a database to use in at least one of the applications 270.

The package manager 247 may manage installation or update of an application distributed in a form of a package file.

The connectivity manager 248 may manage a wireless connection of the electronic device 100. For example, the connectivity manager 248 may transmit text information received from the text conversion connection manager 254 to the server and transmit another text received from the server to the text conversion connection manager 254. Here, the server may include a translation server that can convert a text to a reference language.

The notification manager 249 may display or notify of an event such as an arrival message, appointment, and proximity notification. In this case, the notification manager 249 may display or notify of an event with a method that does not disturb a user.

The location manager 250 may manage location information of the electronic device 100.

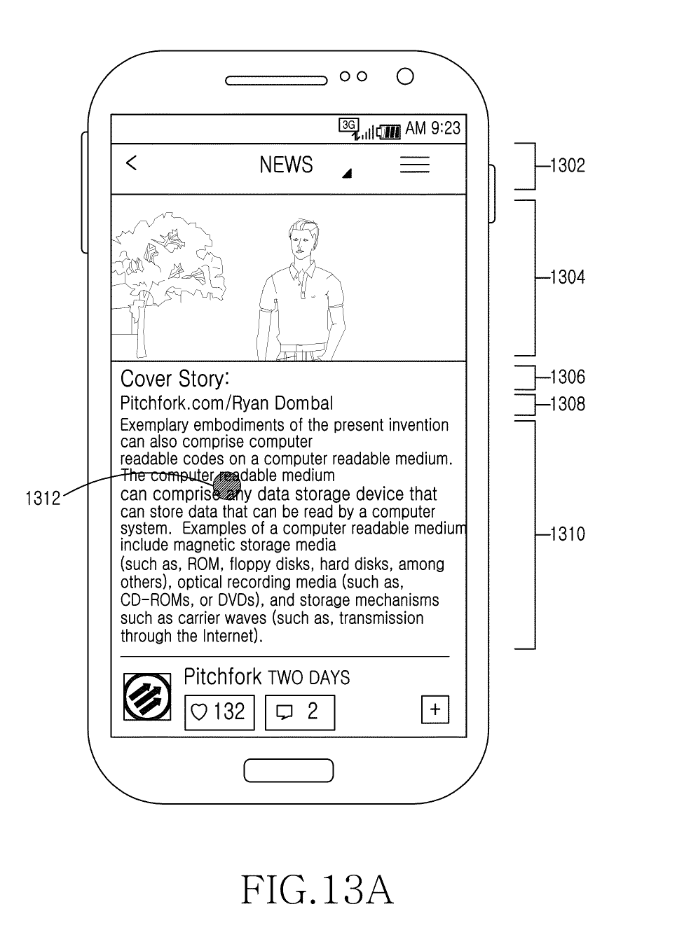

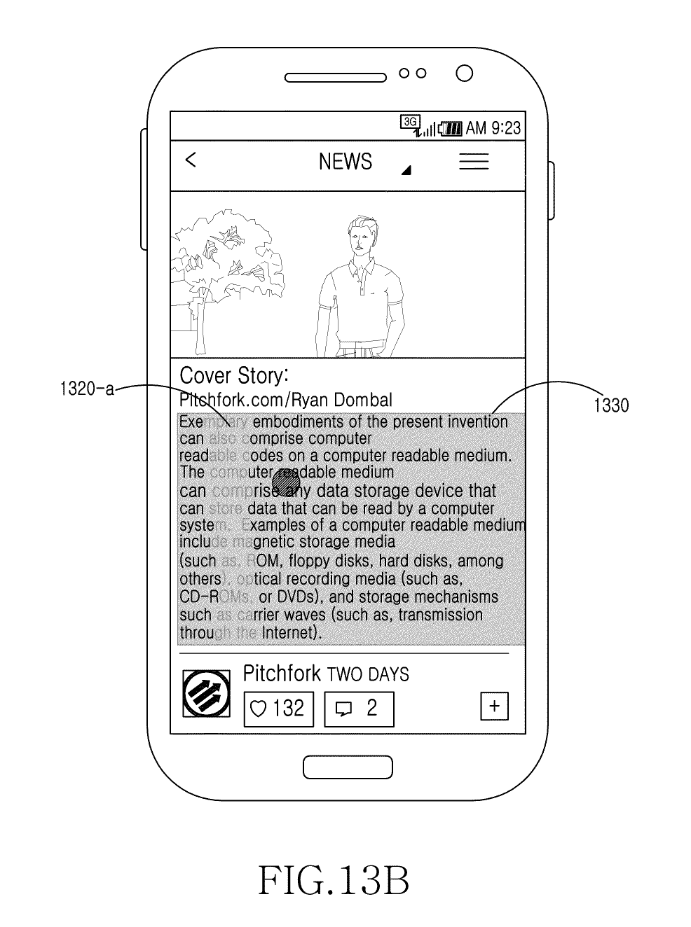

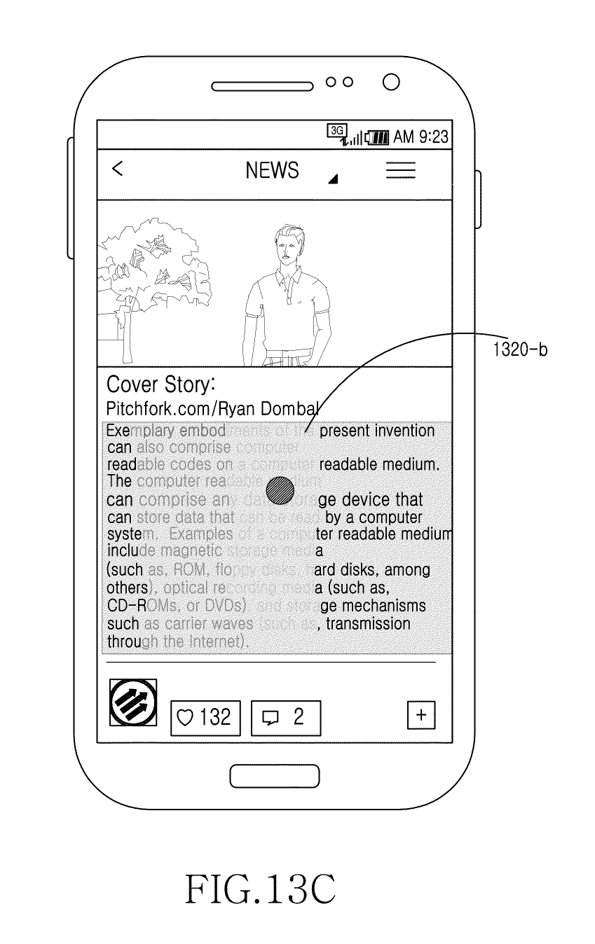

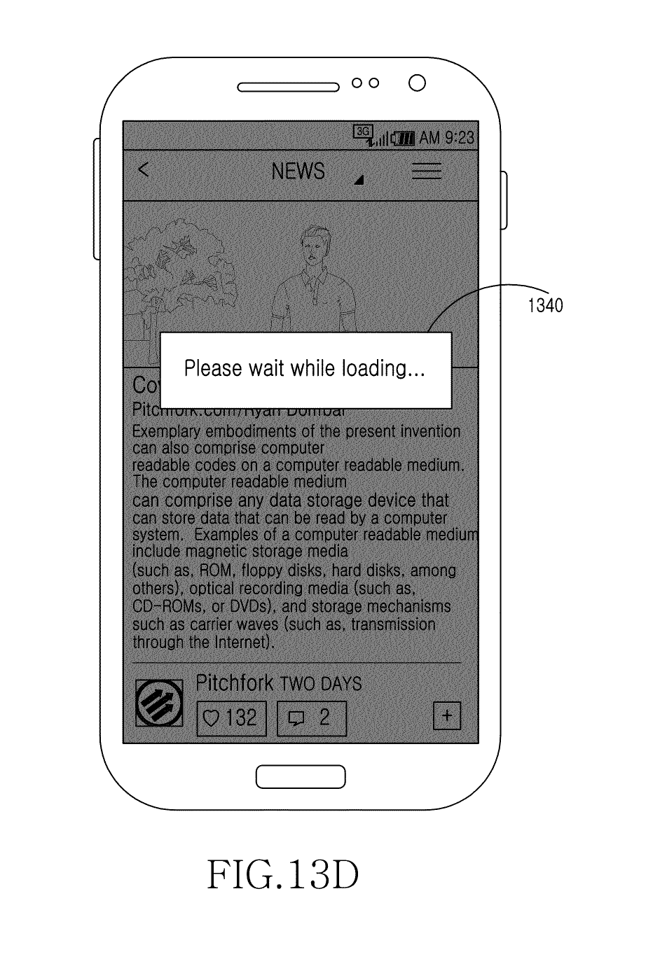

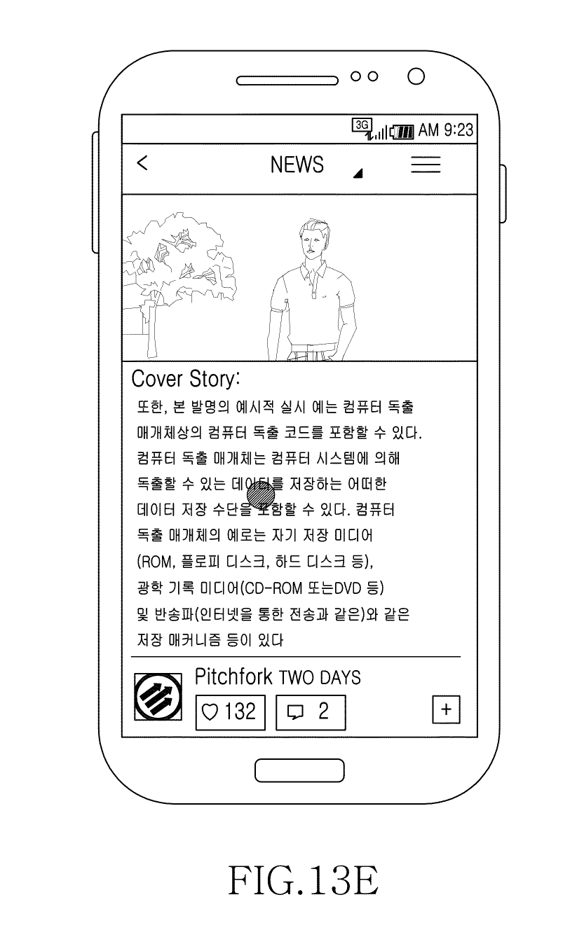

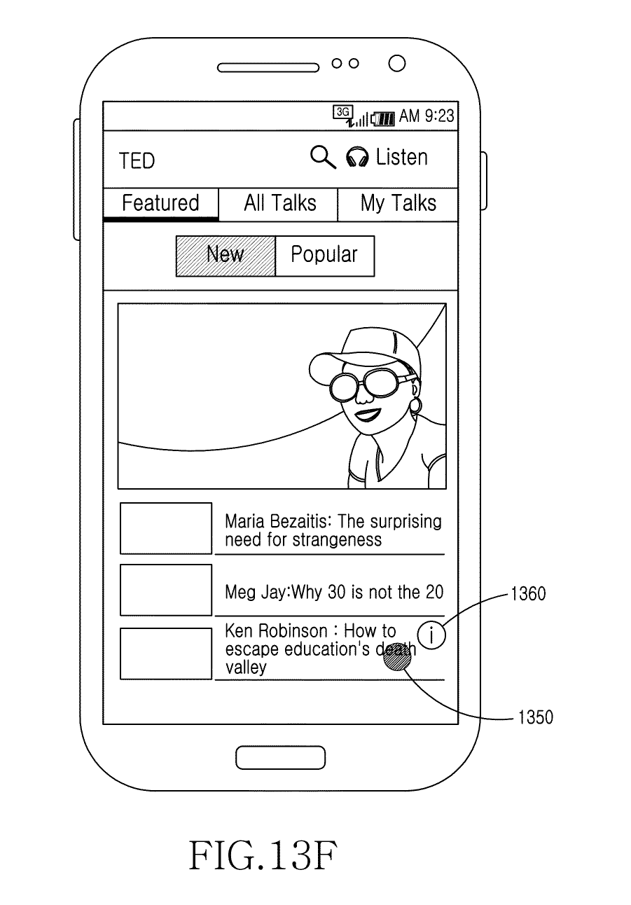

The graphic manager 251 may manage a graphic effect to be provided to a user or a user interface related thereto. The graphic manager 251 may manage a graphic effect for a text conversion service. For example, in order to represent text extraction information for a text conversion in the text conversion manager 253, the graphic manager 251 may display scanning effects 1320-a (FIG. 13B) and 1320-b (FIG. 13C) of a conversion area. In another example, the graphic manager 251 may display information 1360 (FIG. 13F) on whether an area in which a user input determined in the text conversion manager 253 is detected can be converted to a text. In another example, the graphic manager 251 may display a guidance phrase 1340 (FIG. 13D) representing that a text is being transmitted to and/or received from an external server in the text conversion connection manager 254. In another example, when text lengths of an original text and a conversion text replaced by the text conversion manager 253 are different, in order to display the conversion text, the graphic manager 251 may change a layout of the conversion area.

The security manager 252 may provide a security function used for system security or user authentication.

The display manager 255 may manage at least one view constituting a screen displayed in the display unit 150.

The display manager 255 may transmit display area information to the text conversion manager 253 for a text conversion service. For example, the display manager 255 may transmit a kind of a display area in which a user input is detected to the text conversion manager 253. Here, the kind of display area may include at least one of a text display area, a web display area, an image display area, or a custom view. In another example, the display manager 255 may extract a view object included in a conversion area determined in the text conversion manager 253 and transmit the view object to the text conversion manager 253. Here, the view object may represent data included in a display area.

The display manager 255 may set a view object received from the text conversion manager 253 for a text conversion service to a view object of the conversion area.

The display manager 255 may include a text display manager 256, a web display manager 257, or a user display manager 258.

The text display manager 256 may manage a text display area of at least one display area constituting a screen displayed in the display unit 150. For example, when a text display area is included in a conversion area determined in the text conversion manager 253, the text display manager 256 may extract a view object in a text display area included in the conversion area and transmit the view object to the text conversion manager 253. In another example, when a text display area is included in a conversion area determined in the text conversion manager 253, the text display manager 256 may set a view object including a converted text received from the text conversion manager 253 to a view object of a text display area included in the conversion area.

The web display manager 257 may manage a web display area of at least one display area constituting a screen displayed in the display unit 150. For example, when a web display area is included in a conversion area determined in the text conversion manager 253, the web display manager 257 may extract a view object in the web display area included in the conversion area and transmit the view object to the text conversion manager 253. In another example, when a web display area is included in a conversion area determined in the text conversion manager 253, the web display manager 257 may set a view object including a converted text received from the text conversion manager 253 to a view object of a web display area included in the conversion area.

The user display manager 258 may manage a custom view of at least one display area constituting a screen displayed in the display unit 150. For example, when a custom view is included in a conversion area determined in the text conversion manager 253, the user display manager 258 may extract a view object in a custom view included in the conversion area and transmit the view object to the text conversion manager 253. In another example, when a custom view is included in a conversion area determined in the text conversion manager 253, the user display manager 258 may set a view object including a converted text received from the text conversion manager 253 to a view object of a custom view included in the conversion area.

The text conversion manager 253 may provide a text conversion service to a conversion area. In this case, the text conversion manager 253 may determine a conversion area based on input information received through the input unit 140, extract a text included in the conversion area, and transmit the text to the text conversion connection manager 254. For example, the text conversion manager 253 may extract a text from a view object received from the display manager 255 and transmit the text to the text conversion connection manager 254. For example, when a text conversion event occurs, the text conversion manager 253 may determine one or more of at least one view constituting a screen displayed in the display unit 150 to a conversion area. In this case, the text conversion manager 253 may recognize a display area in which a user input for which a text conversion event occurs is detected to a conversion area or may recognize an entire screen to a conversion area. Here, an input for which a text conversion event occurs may include an input by hovering or touch.

The text conversion manager 253 may set another text received from the text conversion connection manager 254 to a text of a conversion area. For example, the text conversion manager 253 may add another text received from the text conversion connection manager 254 to a view object of a conversion area and transmit the view object to the display manager 255.

The text conversion manager 253 may determine and display whether an area in which an input is detected can be converted to a text. In this case, the text conversion manager 253 may determine and display whether an area in which a preliminary input is detected can be converted to a text. For example, the text conversion manager 253 may determine whether a text for a text conversion can be extracted according to a characteristic of a display area in which an input received from the display manager 255 is detected. In this case, the text conversion manager 253 may recognize a text display area, a web display area, or a custom view that can analyze in the electronic device 100 as a display area that can be converted to a text. Here, a preliminary input does not result in the occurrence of an execution event corresponding to an input, is an input representing a point in which a corresponding input is detected, and may include a C-type touch hover, a pen hover, a mouse pointer hover, a touch, a mouse click, an air gesture, and a pupil input.

In order to transmit a text received from the text conversion manager 253 to an external server, the text conversion connection manager 254 may transmit the text to the connectivity manager 248 and transmit a converted text received from the connectivity manager 248 to the text conversion manager 253. In this case, when the text conversion connection manager 254 transmits a text to the connectivity manager 248, the text conversion connection manager 254 may transmit a text received from the text conversion manager 253 together with language information for converting to a text.

When the electronic device 100 provides a phone function, the middleware 230 may further include a communication manager (not shown) for managing audio dedicated communication or an audiovisual communication function of the electronic device 100.

The middleware 230 may generate and use a new middleware module through various function combinations of the above-described internal constituent element modules. In order to provide a distinguished function, the middleware 230 may provide a specialized module on a kind basis of an operation system. Further, the middleware 230 may dynamically partially delete an existing constituent element or add new constituent elements. Therefore, a constituent element described in an embodiment of the present disclosure may be partially omitted or another constituent element may be further included, or the constituent element may be replaced with a constituent element that has another name and that performs a similar function.

The API 260 may be provided with another configuration according to an operation system with a set of API programming functions. For example, an Android or iOS operation system may provide an API set on a platform basis. In another example, a Tizen operation system may provide two or more API sets on a platform basis.

The application 270 may include a preloaded application installed by a provider or an external application installed by a user.

In the foregoing embodiment, the text conversion manager 253 may provide a text conversion service. The text conversion manager 253 of the middleware 230 may include location information of a text conversion engine stored at the application 270. For example, when a text conversion event occurs, the text conversion manager 253 may load a text conversion engine stored at the application 270 and provide a text conversion service. A user of the electronic device 100 may upgrade a text conversion engine similar to a method of upgrading an application. For example, a user of the electronic device 100 may extend custom view information that can support in a text conversion engine through a simple application upgrade instead of a firmware upgrade.

In the foregoing embodiment, the middleware 230 may include the text conversion manager 253 for providing a text conversion service and the text conversion connection manager 254 for transmitting and receiving a text to and from the external server.

In another embodiment, the middleware 230 may include the text conversion manager 253 for transmitting and receiving a text to and from an external server and a text conversion service.

In the foregoing embodiment, the text conversion manager 253 of the middleware 230 may determine whether a text for a text conversion can be extracted according to a characteristic of a display area in which a user input received from the display manager 255 is detected.

In another embodiment, the middleware 230 may include the display manager 255 that can determine whether a text for a text conversion can be extracted according to a characteristic of a display area in which a user input is detected.

At least a portion of the programming module 200 may be implemented with an instruction stored at a computer readable storage medium. Here, the computer readable storage medium may include the memory 130. Further, at least a portion of the programming module 200 may be implemented in the processor 120.

Names of constituent elements of the programming module 200 according to an embodiment of the present disclosure may be changed according to a kind of an operation system.

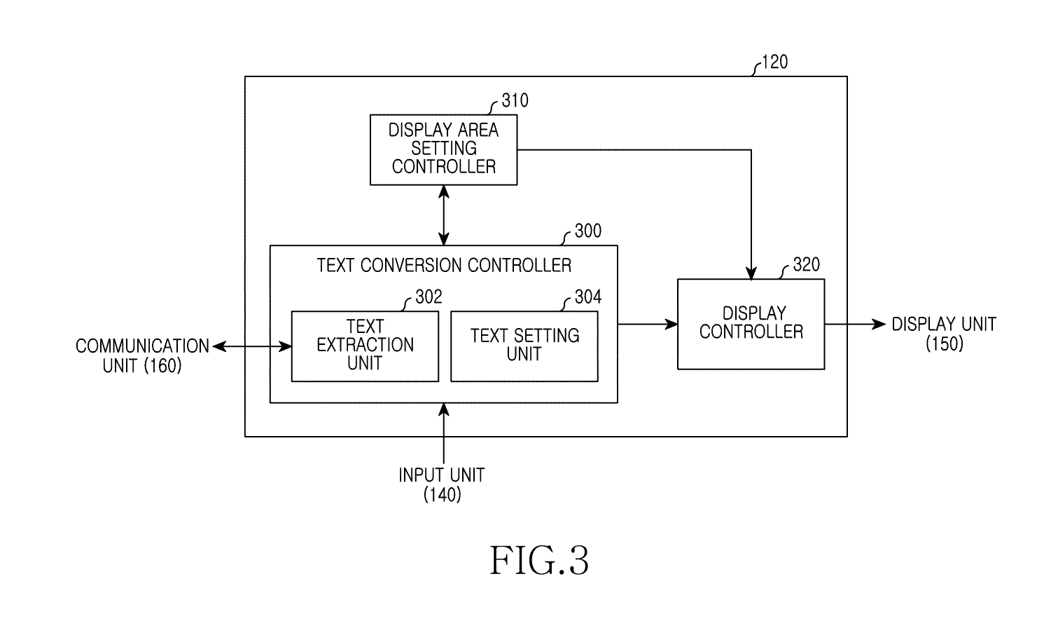

FIG. 3 is a block diagram illustrating a configuration of a processor according to an embodiment of the present disclosure. Hereinafter, a text conversion service will be described with reference to a screen configuration of FIGS. 13A, 13B, 13C, 13D, 13E, and 13F. FIGS. 13A, 13B, 13C, 13D, 13E, and 13F are diagrams illustrating a screen configuration for a text conversion service according to an embodiment of the present disclosure.

Referring to FIG. 3, the processor 120 may include a text conversion controller 300, a display area setting controller 310, or a display controller 320.

The text conversion controller 300 may determine a conversion area using the text conversion manager 253 of the middleware 230. Here, the conversion area may include at least one screen area for converting a text of at least one screen area constituting a screen displayed in the display unit 150. For example, when a text conversion event occurs, the text conversion controller 300 may determine a view in which an input for which a text conversion event is detected among at least one view constituting a screen displayed in the display unit 150 as a conversion area. When a view in which an input is detected is a web display area constituting a web page, the text conversion controller 300 may determine a conversion area using a tag (e.g., <p>) that designates a paragraph of a web page. In another example, when a text conversion event occurs, the text conversion controller 300 may determine a screen displayed in the display unit 150 as a conversion area. Here, an input for which a text conversion event occurs may include an input by hovering or touch.

The text conversion controller 300 may determine whether an area in which an input is detected can be converted to a text. In this case, the text conversion controller 300 may determine whether an area in which a preliminary input is detected can be converted to a text. For example, the text conversion controller 300 may determine whether a text for a text conversion can be extracted according to a characteristic of a display area in which an input received from the display area setting controller 310 is detected. The text conversion controller 300 may recognize a text display area, a web display area, or a custom view that can be analyzed by the electronic device 100 as a display area that can be converted to a text.

The text conversion controller 300 may extract a text included in the conversion area using a text extraction unit 302. In this case, the text extraction unit 302 may extract a text from a view object of a conversion area received from the display area setting controller 310. For example, when a conversion area determined in the text conversion controller 300 is a text display area defined in an Android operation system, the text extraction unit 302 may extract a text included in a text display area using a “getText function” of the Android operating system. In another example, when a conversion area determined in the text conversion controller 300 is a web display area constituting a web page, the text extraction unit 302 may extract a text included in a tag that designates a paragraph. In another example, when a conversion area determined in the text conversion controller 300 is a custom view, the text extraction unit 302 may extract a text included in the custom view using a text extraction function defined according to the custom view.

The text conversion controller 300 may transmit a text of a conversion area extracted in the text extraction unit 302 to the external server through the communication unit 160 using the text conversion connection manager 254 of the middleware 230. Thereafter, the text conversion controller 300 may transmit another text received from the external server through the communication unit 160 to the text setting unit 304.

The text conversion controller 300 may convert a text of a conversion area to another text received from the external server using the text setting unit 304. For example, the text setting unit 304 may add another text received from the external server to a view object of a conversion area received from the display area setting controller 310 and transmit the other text to the display area setting controller 310. Here, another text may be a text that translates a text of a conversion area into another language. For example, when a conversion area determined in the text conversion controller 300 is a text display area defined in the Android operation system, the text setting unit 304 may convert a text included in a text display area to another text using a “SetText function” of the Android operating system. In another example, when the conversion area determined in the text conversion controller 300 is a web display area constituting a web page, the text setting unit 304 may convert a text included in a tag that designates a paragraph to another text. In another example, when a conversion area determined in the text conversion controller 300 is a custom view, the text setting unit 304 may convert a text included in the custom view to another text using a text setting function defined according to the custom view.

By executing the display manager 255 of the middleware 230, the display area setting controller 310 may manage at least one view constituting a screen displayed in the display unit 150. Particularly, the display area setting controller 310 may transmit display area information to the text conversion controller 300 for a text conversion service. For example, the display area setting controller 310 may transmit a kind of a display area in which a user input is detected to the text conversion controller 300. Here, a kind of a display area may include at least one of a text display area, a web display area, an image display area, or a custom view. In another example, the display area setting controller 310 may extract a view object included in a conversion area determined in the text conversion controller 300 and transmit the view object to the text conversion controller 300. Here, the view object may represent data included in the display area.

The display area setting controller 310 may set a view object including a converted text received from the text conversion controller 300 to a view object of a conversion area.

The display controller 320 may provide a user interface with graphics through the display unit 150. In this case, the display controller 320 may control to display a graphic effect for a text conversion service in the display unit 150. For example, when the text extraction unit 302 extracts a text, as shown in FIG. 13B, the display controller 320 may control to display shade 1330 in the conversion area and to display scanning effects 1320-a and 1320-b of a conversion area, as shown in FIGS. 13B and 13C. In another example, while the display controller 320 stands by reception of another text from the server, the display controller 320 may display a guidance phrase 1340 representing reception standby of another text, as shown in FIG. 13D. In another example, the display controller 320 may control to display whether an area in which a user input 1350 is detected can be converted to a text 1360, as shown in FIG. 13F. In another example, when text lengths of an original text and a conversion text replaced by the text conversion controller 300 are different, the display controller 320 may change a layout of a conversion area so as to display a conversion text. Here, a scanning effect may indicate an effect that sequentially moves a light emitting area that represents a scan point within a conversion area in order to represent a display effect that scans a document using a scanner.

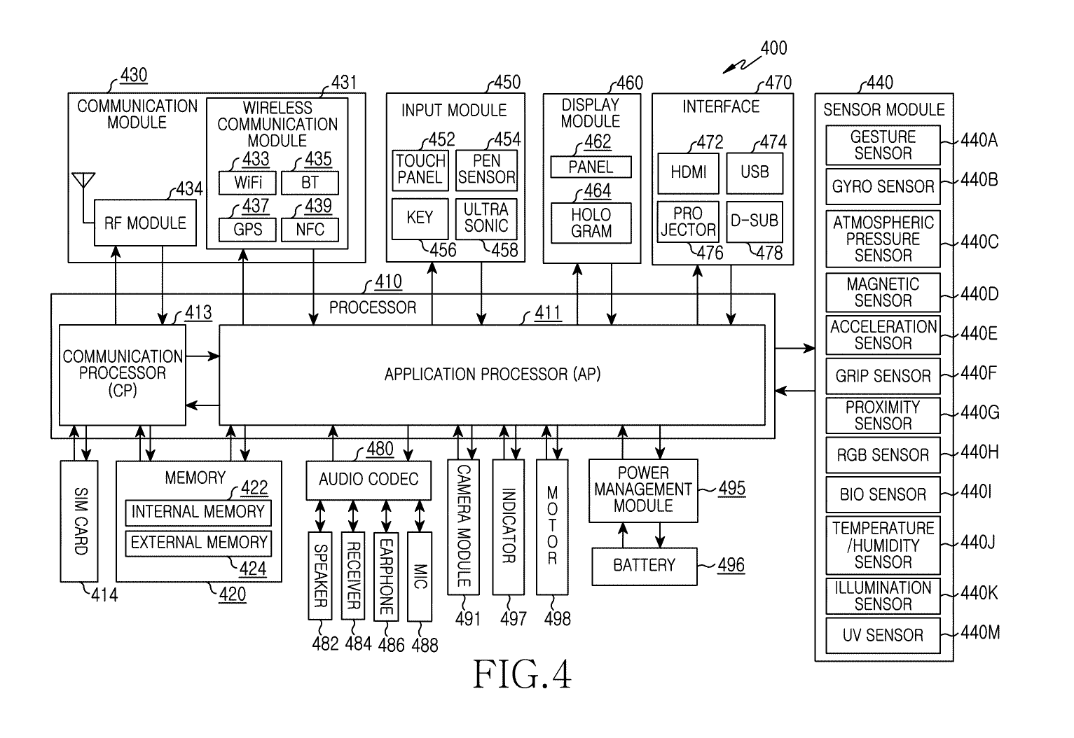

FIG. 4 is a block diagram illustrating a configuration of an electronic device according to an embodiment of the present disclosure. Hereinafter, a detailed block configuration of the electronic device 100 of FIG. 1 will be described.

Referring to FIG. 4, an electronic device 400 may include at least one processor 410, a subscriber identity module (SIM) card 414, a memory 420, a communication unit 430, a sensor unit 440, a input unit 450, a display unit 460, an interface 470, an audio codec 480, a camera unit 491, a power management unit 495, an indicator 497, a motor 498, and any other similar and/or suitable component.

The processor 410 may include at least one application processor (AP) 411 or at least one communication processor (CP) 413. FIG. 4 illustrates that the AP 411 and the CP 413 are included within a processor 410, but the AP 411 and the CP 413 may be included within different integrated circuit (IC) packages, respectively. In another example, the AP 411 and the CP 413 may be included within an IC package. Additionally, the processor 410 may further include a graphics processing unit (GPU) (not shown).

The AP 411 may control a plurality of hardware or software elements connected to the AP 411 by driving an operation system or an application program and perform various data processing and calculations including multimedia data. For example, by executing the text conversion manager 253 included in the middleware 132 of the memory 420, the AP 411 may control to provide a text conversion service of a conversion area. Specifically, when the AP 411 detects that a text conversion event occurs, the AP 411 may determine a conversion area based on an area in which an input is detected through the input unit 450. Thereafter, the AP 411 may control to extract a text included in the conversion area, to convert the extracted text with a specific language, to convert and display the conversion area to a converted text. Here, the AP 411 may be implemented with a system on chip (SoC).

The CP 413 may perform a function of managing a data link for communication between other electronic devices connected by a network to the electronic device 400 and converting a communication protocol. Here, the CP 413 may be implemented with a SoC.

The CP 413 may perform at least a portion of a multimedia control function. For example, the CP 413 may perform identification and authentication of the electronic device within a communication network using a subscriber identity module (e.g., SIM card 414). In another example, the CP 413 may provide services such as audio dedicated communication, audiovisual communication, a character message, or packet data to a user.

The CP 413 may control data transmission and reception of the radio frequency (RF) unit 434.

The SIM card 414 may be a card that implements a subscriber identity module and be inserted into a slot formed at a specific location of the electronic device 400. For example, the SIM card 414 may include intrinsic identification information (e.g., Integrated Circuit Card Identifier (ICCID)) or subscriber information (e.g., International Mobile Subscriber Identity (IMSI)).

The memory 420 may include an internal memory 422 or an external memory 424. The internal memory 422 may be built in and the external memory 424 may be removable.

The built-in memory 422 may include at least one of a volatile memory (e.g., a dynamic random access memory (DRAM), a static random access memory (SRAM), a synchronous dynamic random access memory (SDRAM)), or a non-volatile memory (e.g., a one-time programmable read only memory (OTPROM), a programmable read only memory (PROM), an erasable and programmable read only memory (EPROM), an electrically erasable and programmable read only memory (EEPROM), a mask read only memory (ROM), a flash ROM, a NAND flash memory, and a NOR flash memory). In this case, the built-in memory 422 may have a form of a solid state drive (SSD).

The AP 411 or the CP 413 may load and process an instruction or data received from at least one of other constituent elements or a non-volatile memory connected to each other in the volatility memory. Further, the AP 411 or the CP 413 may store data received from at least one other constituent element or generated by at least one other constituent element at the non-volatile memory.

The removable memory 424 may include a compact flash (CF), secure digital (SD), micro secure digital (Micro-SD), mini secure digital (Mini-SD), extreme digital (xD), or a memory stick.

The communication unit 430 may include a wireless communication unit 431 or a RF unit 434.

The wireless communication unit 431 may include Wi-Fi 433, BT 435, a GPS 437, or NFC 439. For example, the wireless communication unit 431 may provide a wireless communication function using a radio frequency. Additionally, the wireless communication unit 431 may include a network interface (e.g., a LAN card) or a modem for connecting the electronic device 400 to a network (e.g., Internet, a LAN, a wide area network (WAN), a telecommunication network, a cellular network, a satellite network, or a POTS).

The RF unit 434 may perform transmission and reception of data, for example, transmission and reception of an RF signal or an electronic signal. For example, the RF unit 434 may include a transceiver, a power amp module (PAM), a frequency filter, or a low noise amplifier (LNA). Further, the RF unit 434 may further include a component (e.g., a conductor or a conductive wire) for transmitting and receiving electromagnetic waves on free space in wireless communication.

The sensor unit 440 may measure a physical quantity or detect an operation state of an electronic device and convert measured or detected information to an electric signal. For example, the sensor unit 440 may include a gesture sensor 440A, a gyro sensor 440B, an atmospheric pressure sensor 440C, a magnetic sensor 440D, an acceleration sensor 440E, a grip sensor 440F, a proximity sensor 440G, a red, green, and blue (RGB) sensor 440H, a bio sensor 440I, a temperature/humidity sensor 440J, an illumination sensor 440K, and a ultra violet (UV) sensor 440M. In this case, the sensor unit 440 may further include an E-nose sensor (not shown), an electromyography sensor (EMG sensor) (not shown), an electroencephalogram sensor (EEG sensor) (not shown), an electrocardiogram sensor (ECG sensor) (not shown), or a fingerprint sensor in addition to constituent elements of FIG. 4. Further, the sensor unit 440 may further include a control circuit to control at least one sensor included in the sensor unit 440.

The input unit 450 may include a touch panel 452, a pen sensor 454, a key 456, or an ultrasonic wave input device 458.

The touch panel 452 may recognize a touch input with at least one method of a capacitive, resistive, infrared ray, or ultrasonic wave method. When the touch panel 452 uses a capacitive touch method, the touch panel 452 may recognize a proximity touch as well as a direct touch. Additionally, the touch panel 452 may further include a controller (not shown). Further, in order to provide a haptic reaction to the user, the touch panel 452 may further include a tactile layer.

The pen sensor 454 may be implemented using a separate recognition sheet similar to reception of a touch input of the user.

The key 456 may include a keypad or a touch key.

The ultrasonic wave input device 458 is a device that can determine data by detecting a sound wave and may perform wireless recognition.

Additionally, the electronic device 400 may receive a user input from an external device (e.g., a network, a computer, or a server) through the communication unit 430.

The display unit 460 may include a panel 462 or a hologram 464.

The panel 462 may include a liquid-crystal display (LCD) or an active-matrix organic light-emitting diode (AM-OLED). Further, the panel 462 may be implemented with a flexible, transparent, or wearable method. In this case, the panel 462 and the touch panel 452 may be formed in a module.

The hologram 464 may show a stereoscopic image in the air using interference of light.

Additionally, the display unit 460 may further include a control circuit that controls the panel 462 or the hologram 464.

The interface 470 may include a High Definition Multimedia Interface (HDMI) 472, a USB 474, a projector 476, or a D-sub 478. Additionally, the interface 470 is not shown, but may further include a SD/Multimedia Card (MMC) or infrared data association (IrDA).

The audio codec 480 may interactively convert a voice and an electric signal. For example, the audio codec 480 may convert voice information input or output through a speaker 482, a receiver 484, an earphone 486, or a microphone 488.

The camera unit 491 may photograph an image and a moving picture. For example, the camera unit 491 may include at least one image sensor (e.g., a front surface lens or a rear surface lens), an image signal processor (ISP) (not shown), or a flash light emitting diode (LED) (not shown).

The power management unit 495 may manage power of the electronic device 400. For example, the power management unit 495 may include a power management integrated circuit (PMIC), a charger integrated circuit (charge IC), or a battery gauge. The PMIC may be mounted within an integrated circuit or a SoC semiconductor. The charge IC may charge the battery 496 and prevent an overvoltage or an overcurrent from being injected from a charger. In this case, the charge IC may include a charge IC for at least one of a wire charge method or a wireless charge method. Here, the wireless charge method may include a magnetic resonance method, a magnetic induction method, or an electromagnetic wave method.

The battery gauge may measure a residual quantity of the battery 496 and a voltage, a current, or a temperature while charging.

The battery 496 may supply electricity to supply power. In this case, the battery 496 may be a rechargeable battery.

The indicator 497 may display state information of the electronic device 400 or a partial constituent element (e.g., the AP 411) included in the electronic device 400. For example, the indicator 497 may display a booting state, a message state, or a charge state.

The motor 498 may convert an electrical signal to a mechanical vibration.

Although not shown, the electronic device 400 may include a processing device (e.g., a GPU) for supporting mobile TV. For example, the processing device for supporting the mobile TV may process media data according to a specification of digital multimedia broadcasting (DMB), digital video broadcasting (DVB), or media flow.

Names of the above-described constituent elements of the electronic device 400 according to an embodiment of the present disclosure may be changed according to a kind of the electronic device 400. Further, the electronic device 400 may include at least one of the constituent elements, may be formed in a form in which some elements are omitted, or may further include additional constituent elements according to a kind of the electronic device 400.

In the foregoing embodiment, in the electronic device 400, constituent elements of the CP 413, the power management unit 495, or the memory 420 may be constituent elements separate from the AP 411.

In another embodiment, the electronic device 400 may be implemented so that the AP 411 includes at least a portion of constituent elements of the CP 413, the power management unit 495, or the memory 420.

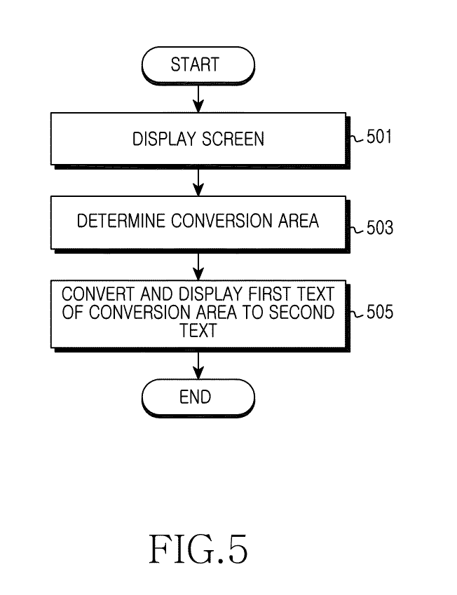

FIG. 5 is a flowchart illustrating a process of providing a text conversion service in an electronic device according to an embodiment of the present disclosure.

Referring to FIG. 5, the electronic device may display a screen at operation 501. For example, the electronic device may display a screen formed with a plurality of display areas 1302, 1304, 1306, 1308, and 1310 in the display unit 150, as shown in FIG. 13A.

The electronic device may determine a conversion area at operation 503. For example, the electronic device may determine at least one display area in which an input is detected as a conversion area. For example, the electronic device may determine at least one display area as a conversion area using a hovering input or a touch input detected through the input unit 140.

The electronic device may convert and display a first text of the conversion area to a second text at operation 505. Here, the second text may be a text in which the first text is translated into a reference language. For example, the electronic device may transmit a first text extracted in the conversion area to the external server. The electronic device may convert and display the first text included in the conversion area to a second text, which is a translation received from the server.

When the screen (e.g., an entire screen) displayed in the display unit 150 is set to the conversion area in operation 503 of FIG. 5, the electronic device may extract a text on each display area included in the screen and convert the text to another text (e.g., a translation). For example, the electronic device may detect at least one display area that can be converted to a text among display areas included in the screen. By performing sequentially or in parallel operation 505 of FIG. 5 in each of at least one display area that can be converted to a text, the electronic device may convert and display a text included in each display area to another text (e.g., a translation).

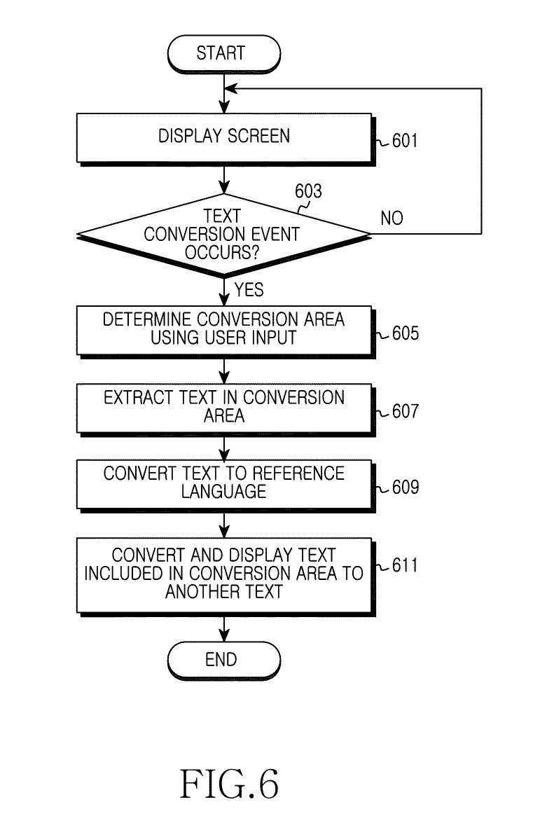

FIG. 6 is a flowchart illustrating a process of providing a text conversion service in an electronic device according to an embodiment of the present disclosure.

Referring to FIG. 6, the electronic device may display a screen at operation 601. For example, the electronic device may display a screen formed with a plurality of display areas 1302, 1304, 1306, 1308, and 1310 in the display unit 150, as shown in FIG. 13A.

The electronic device may determine whether a text conversion event occurs at operation 603. For example, the electronic device may determine whether a hovering input of at least one display area of a plurality of display areas included in the screen is continuously maintained for a reference time. In another example, the electronic device may determine whether a touch input of at least one display area of a plurality of display areas included in the screen is continuously maintained for a reference time.

If a text conversion event does not occur, the electronic device may maintain the display of the screen at operation 601.

If a text conversion event occurs, the electronic device may determine a conversion area using a user input at operation 605.

The electronic device may extract at least one text included in the conversion area at operation 607.

The electronic device may convert at least one text extracted in the conversion area to a reference language at operation 609. For example, the electronic device may determine at least one text extracted in the conversion area to another text converted to a reference language. Here, the reference language may be selected according to a user's input information or may be set to a system language of the electronic device. Here, the system language may represent a basic language set to provide a service in the electronic device.

The electronic device may convert and display at least one text included in the conversion area to another text at operation 611. For example, as shown in FIG. 13B, when translating at least one text included in the conversion area 1310 into Korean, the electronic device may convert and display a text included in the conversion area 1310 to another text translated into Korean, as shown in FIG. 13E. When lengths of an original text included in the conversion area and a text included in a translation are different, the electronic device may convert a layout of the screen and display a translation.

When a screen displayed in the display unit 150 is set to a conversion area in operation 605 of FIG. 6, by performing operations 607 to 611 on each display area included in the screen, the electronic device may convert a text included in a corresponding display area to another text (e.g., a translation). In this case, the electronic device may provide a text conversion service only to at least one display area that can be converted to a text among display areas included in the screen.

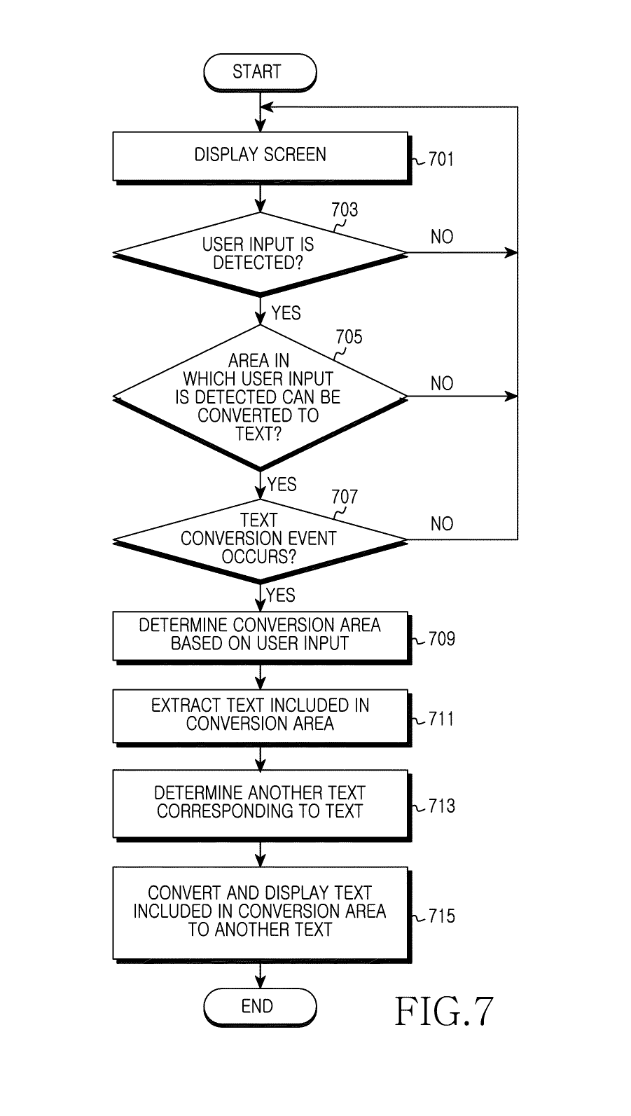

FIG. 7 is a flowchart illustrating a process of providing a text conversion service in an electronic device according to an embodiment of the present disclosure.

Referring to FIG. 7, the electronic device may display a screen at operation 701.

The electronic device may determine whether a user input is detected at operation 703.

If a user input is not detected, the electronic device may maintain the display of the screen at operation 701.

If a user input is detected, the electronic device may determine whether an area in which a user input is detected can be converted to a text at operation 705. For example, when a preliminary input is detected, the electronic device may determine whether a text for a text conversion can be extracted based on a characteristic of a display area in which a user input is detected. In this case, the electronic device may recognize a text display area, a web display area, or a custom view that can be analyzed by the electronic device as a display area that can be converted to a text. Further, as shown in FIG. 13F, the electronic device may display whether an area in which a user input is detected can be converted to a text 1360.

If an area in which a user input is detected cannot be converted to a text, the electronic device may maintain the display of the screen at operation 701.

If an area in which a user input is detected can be converted to a text, the electronic device may determine whether a text conversion event occurs at operation 707.

If a text conversion event does not occur, the electronic device may maintain the display of the screen at operation 701.

If a text conversion event occurs, the electronic device may determine a conversion area based on a user input at operation 709.

The electronic device may extract at least one text included in the conversion area at operation 711.

The electronic device may determine another text corresponding to at least one text extracted in the conversion area at operation 713. For example, the electronic device may determine at least one text extracted from the conversion area to another text converted to a reference language. Here, the reference language may be selected according to a user's input information or may be set to a system language of the electronic device.

The electronic device may convert and display at least one text included in the conversion area to another text (e.g., a translation) at operation 715.

When a screen displayed in the display unit 150 is set to a conversion area, the electronic device may perform operations 711 to 715 on each display area included in the screen and convert a text included in a corresponding display area to another text (e.g., a translation) at operation 709. In this case, the electronic device may provide a text conversion service only to at least one display area that can be converted to a text among display areas included in the screen.

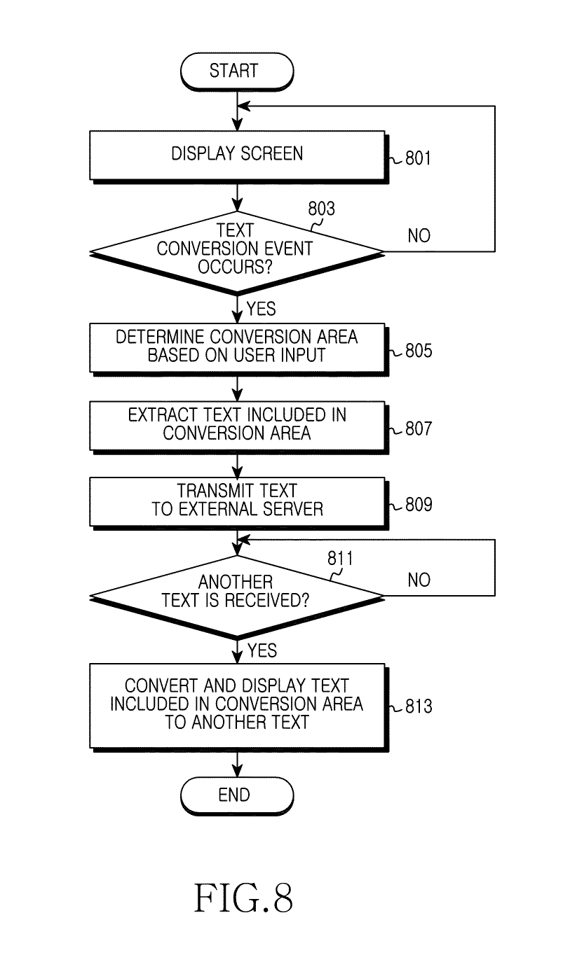

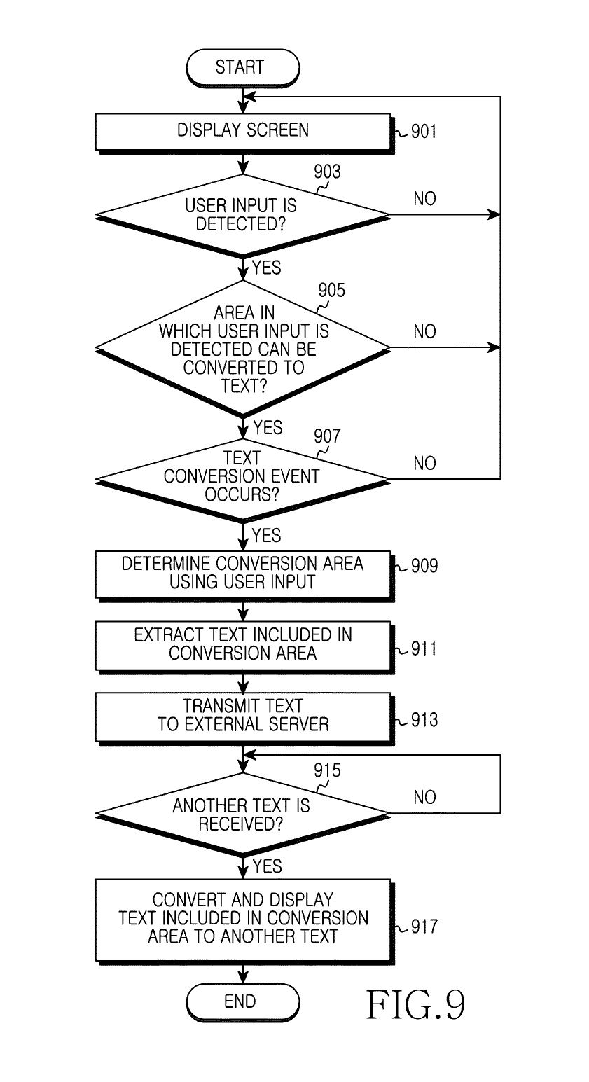

As described above, the electronic device may convert and display at least one text included in the conversion area to another text. In this case, as shown in FIG. 8 or 9, the electronic device may request a text conversion of at least one text included in the conversion area to the external server.

FIG. 8 is a flowchart illustrating a process of providing a text conversion service using a server in an electronic according to an embodiment of the present disclosure.

Referring to FIG. 8, the electronic device may display a screen at operation 801.

The electronic device may determine whether a text conversion event occurs at operation 803.

If a text conversion event does not occur, the electronic device may maintain the display of the screen at operation 801.

If a text conversion event occurs, the electronic device may determine a conversion area based on a user input at operation 805.

The electronic device may extract at least one text included in the conversion area at operation 807.

The electronic device may transmit at least one text extracted in the conversion area to an external server at operation 809. For example, the electronic device may transmit at least one text extracted in the conversion area and reference language information to convert the corresponding text to the external server. In this case, as shown in FIG. 13D, the electronic device may display a guidance phrase 1340 representing that the electronic device is standing by while a converted text is to be received from the server.

The electronic device may determine whether another text (e.g., a translation) is received from the external server at operation 811. After a text to convert is transmitted to the external server, when another text is not received for a reference time, the electronic device may transmit again the text to convert to the external server.

The electronic device may convert and display at least one text included in the conversion area to another text at operation 813. For example, as shown in FIG. 13B, when at least one text included in the conversion area 1310 is translated into Korean, as shown in FIG. 13E, the electronic device may convert and display a text included in the conversion area 1310 to another text translated into Korean. When lengths of an original text included in the conversion area and a text included in a translation are different, the electronic device may convert a layout of a screen and display the translation.

When the screen displayed in the display unit 150 is set to the conversion area in operation 805 of FIG. 8, the electronic device may perform operations 807 to 813 on each display area included in the screen and convert a text included in a corresponding display area to another text. The electronic device may provide a text conversion service only to at least one display area that can be converted to a text among display areas included in the screen.

FIG. 9 is a flowchart illustrating a process of providing a text conversion service using a server in an electronic device according to an embodiment of the present disclosure.

Referring to FIG. 9, the electronic device may display a screen at operation 901.

The electronic device may determine whether a user input is detected at operation 903.

If a user input is not detected, the electronic device may maintain the display of the screen at operation 901.

If a user input is detected, the electronic device may determine whether an area in which a user input is detected can be converted to a text at operation 905. For example, the electronic device may determine whether an area in which a preliminary input is detected can be converted to a text.

If an area in which a user input is detected cannot be converted to a text, the electronic device may maintain the display of the screen at operation 901.

If an area in which a user input is detected can be converted to a text, the electronic device may determine whether a text conversion event occurs at operation 907.

If a text conversion event does not occur, the electronic device may maintain the display of the screen at operation 901.

If a text conversion event occurs, the electronic device may determine a conversion area using a user input at operation 909.

The electronic device may extract at least one text included in the conversion area at operation 911.

The electronic device may transmit at least one text extracted in the conversion area to the external server at operation 913. For example, the electronic device may transmit at least one text extracted in the conversion area and reference language information to convert the corresponding text to the external server. In this case, as shown in FIG. 13D, the electronic device may display a guidance phrase 1340 representing that the electronic device is standing by while another text is to be received from the server.

The electronic device may determine whether another text is received from the external server at operation 915. After a text to convert is transmitted to an external server, when another text is not received for a reference time, the electronic device may transmit again a text to convert to the external server.

The electronic device may convert and display at least one text included in the conversion area to another text at operation 917. For example, as shown in FIG. 13B, when at least one text included in a conversion area 1310 is translated into Korean, as shown in FIG. 13E, the electronic device may convert and display a text included in the conversion area 1310 to another text translated into Korean. When lengths of an original text included in a conversion area and a text included in a translation are different, the electronic device may convert a layout of the screen and display the translation.

When the screen displayed in the display unit 150 is set to a conversion area in operation 909 of FIG. 9, the electronic device may perform operations 911 to 917 on each display area included in the screen, thereby converting a text included in a corresponding display area. In this case, the electronic device may provide a text conversion service only to at least one display area that can be converted to be a text among display areas included in the screen.

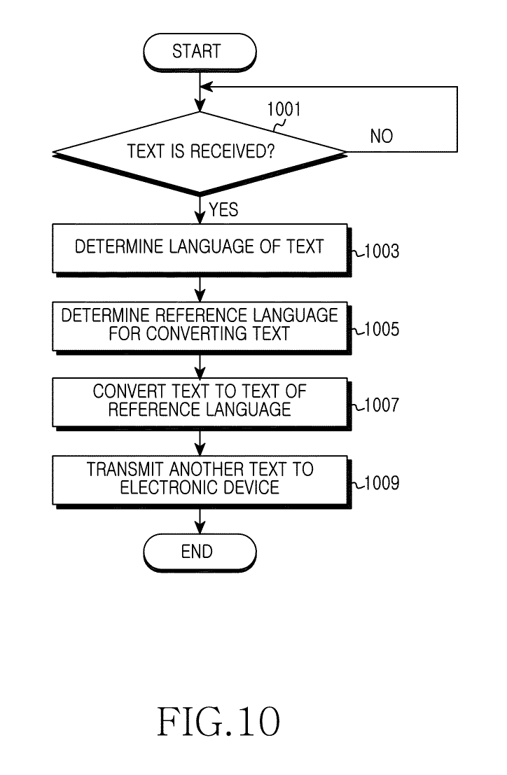

FIG. 10 is a flowchart illustrating a process of converting a text in a server according to an embodiment of the present disclosure.

Referring to FIG. 10, the server may determine whether at least one text in which the electronic device transmits a request for a text conversion is received at operation 1001.

If at least one text in which the electronic device transmits a request for a text conversion is received, the server may determine a language of at least one text in which the electronic device transmits a request for a text conversion at operation 1003. For example, the server may determine a language of a corresponding text based on text information received from the electronic device. In another example, the server may analyze a text received from the electronic device and determine a language of a corresponding text.

The server may determine a reference language for converting a text at operation 1005. For example, the server may determine received reference language information together with at least one text in which the electronic device requests a text conversion.

The server may convert at least one text in which the electronic device requests a text conversion to a text of a reference language at operation 1007. For example, the server may determine another text, which is a translation of at least one text in which the electronic device requests a text conversion.

The server may transmit another text of at least one text in which the electronic device requests a text conversion to the electronic device at operation 1009.

In the foregoing embodiment, the server may determine another text of at least one text in which the electronic device requests a text conversion and transmit the other text to a corresponding electronic device. When the electronic device cannot recognize at least one text that requests a text conversion or does not support a text conversion with a language of a corresponding text, the server may transmit a text conversion failure message to the electronic device.

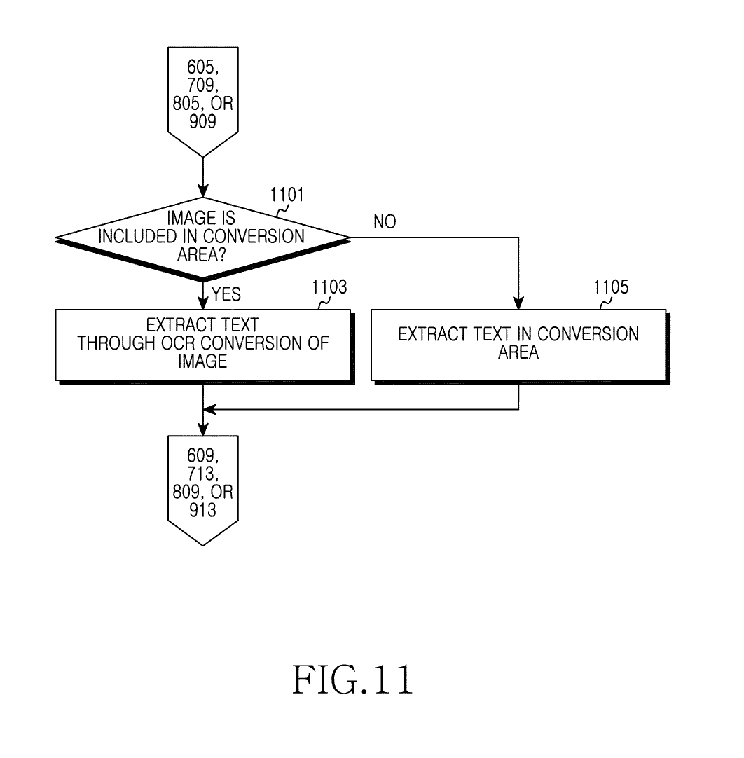

As shown in FIGS. 6 to 9, the electronic device may extract at least one text to convert in a determined conversion area based on a user's input information. Specifically, as shown in FIG. 11, the electronic device may extract at least one text.

FIG. 11 is a flowchart illustrating a process of extracting a text in an electronic device according to an embodiment of the present disclosure.

Referring to FIG. 11, in FIGS. 6 to 9, when a conversion area is determined based on a user's input information at operations 605, 709, 805, or 909, the electronic device may determine whether an image is included in a conversion area at operation 1101. For example, the electronic device may determine whether an image display area is included in a conversion area.

If an image is included in a conversion area, the electronic device may extract at least one text included in an image through an Optical Character Recognition (OCR) conversion of an image at operation 1103. In this case, as shown in FIG. 13B, the electronic device may display 1330 a conversion area 1310, and as shown in FIGS. 13B and 13C, the electronic device may display scanning effects 1320-a and 1320-b of a conversion area and represent that a text for a text conversion is being extracted.

If an image is not included in a conversion area, the electronic device may extract at least one text included in the conversion area at operation 1105. For example, when the conversion area is a text display area defined in an Android operation system, the electronic device may extract a text included in a text display area using a “getText function” of the Android operating system. In another example, when a conversion area is a web display area constituting a web page, the electronic device may extract a text included in a tag indicating a paragraph. In another example, when a conversion area is a custom view, the electronic device may extract a text included in a custom view using a text extraction function defined in the custom view. In this case, as shown in FIG. 13B, the electronic device may display at operation 1330 a conversion area 1310 and as shown in FIGS. 13B and 13C, the electronic device may display scanning effects 1320-a and 1320-b of the conversion area and represent that a text for a text extraction is being extracted.

The electronic device may convert a text extracted in a conversion area in operation 609 of FIG. 6 or operation 713 of FIG. 7 to another text of a reference language or may transmit a text extracted in a conversion area in operation 809 of FIG. 8 or operation 913 of FIG. 9 to the external server (e.g., a translation server).

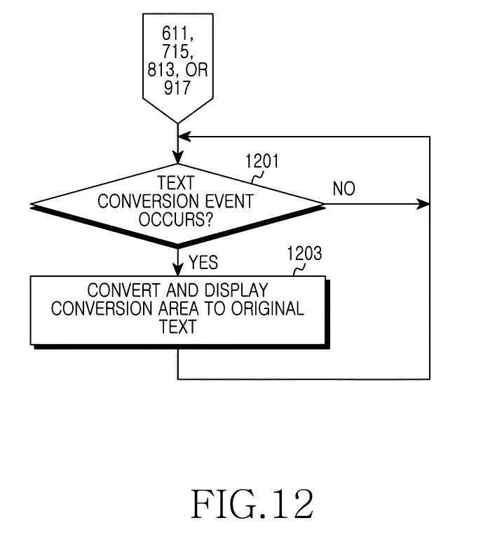

FIG. 12 is a flowchart illustrating a process of converting a display text of a conversion area in an electronic device according to various an embodiment of the present disclosure.

Referring to FIG. 12, in FIGS. 6 to 9, when converting and displaying a conversion area to another text at operations 611, 715, 813, or 917, the electronic device may determine whether a text conversion event occurs in a conversion area at operation 1201. For example, the electronic device may determine whether a hovering input to a conversion area converted and displayed to another text is continuously maintained for a reference time. In another example, the electronic device may determine whether a touch input to a conversion area converted and displayed to another text is continuously maintained for a reference time.

If a text conversion event occurs in a conversion area, the electronic device may convert and display a conversion area to an original text before being converted to a text at operation 1203. For example, when a conversion area is converted to another text, the electronic device may store an original text of the conversion area at the memory 130. Accordingly, when a text conversion event occurs in a conversion area, the electronic device may convert and display another text of a conversion area to an original text stored at the memory 130. In this case, the electronic device may store another text of a conversion area at the memory.

The electronic device may determine whether a text conversion event occurs in a conversion area at operation 1201.

If a text conversion event occurs in a conversion area, the electronic device may convert again and display an original text displayed in the conversion area to another text at operation 1203. For example, the electronic device may convert and display an original text of a conversion area to another text stored at the memory.

Methods described in the claims and/or specification according to various embodiments of the present disclosure can be implemented in a form of hardware, software, or a combination thereof.

When the methods are implemented with software, a non-transitory computer readable storage medium that stores at least one program (e.g., software module) may be provided. At least one program stored at a non-transitory computer readable storage medium may be formed to execute by at least one processor within an electronic device. At least one program may include an instruction that enables a server or an electronic device to execute methods according to various embodiments described in the claims and/or specification of the present disclosure.

Such a program (e.g., software module, software) may be stored at a non-volatile memory including a random access memory (RAM) and a flash memory, a read only memory (ROM), an electrically erasable and programmable ROM (EEPROM), a magnetic disk storage device, a compact disk ROM (CD-ROM), a DVD, or an optical storage device of another form, and a magnetic cassette. Alternatively, the program may be stored at a memory formed with a combination of a portion or the entire thereof. Further, each constituent memory may be included in plural.

Further, the program may be stored at an attachable storage device that may access the electronic device through a communication network such as Internet, intranet, a local area network (LAN), a wireless LAN (WLAN), or a storage area network (SAN) or a communication network formed with a combination thereof. Such a storage device can access to the electronic device through an external port.

Further, a separate storage device on the communication network may access to a portable electronic device.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (e.g., software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are various embodiments of machine-readable storage that are suitable for storing a program or programs comprising instructions that, when executed, implement various embodiments of the present disclosure.

Accordingly, various embodiments provide a program comprising code for implementing an apparatus or a method as claimed in any one of the claims of this specification and a non-transitory machine-readable storage storing such a program. Still further, such programs may be conveyed electronically via any medium such as a communication signal carried over a wired or wireless connection and various embodiments suitably encompass the same.

According to various embodiments of the present disclosure, as an electronic device provides a text conversion service for a text included in a reference area without using a separate application program for a text conversion service, the electronic device may provide a fast text conversion service for a text regardless of a kind of an application program and a screen constituent element.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in electronic device, the method comprising:
displaying a screen including at least one display area;
determining at least one of the at least one display area as a conversion area;
acquiring a first text included in the conversion area; and
providing a second text corresponding to the first text.

2. The method of claim 1, wherein the providing of the second text comprises replacing and displaying the first text with the second text.

3. The method of claim 1, wherein the second text comprises a text in which the first text is translated into a second language, and
wherein the second language comprises a language different from a first language of the first text.

4. The method of claim 3, wherein the second text comprises a text in which the first text is translated into the second language by a translation system of an external server.

5. The method of claim 3, wherein the second text comprises a text in which the first text is translated into the second language by an internal translation system of the electronic device.

6. The method of claim 3, wherein the second language comprises one of a system language of the electronic device and a language set by a user.

7. The method of claim 1, wherein the acquiring of the first text comprises acquiring the first text included in the conversion area using a display manager of an operation system of the electronic device.

8. The method of claim 1, wherein the providing of the second text comprises replacing the first text with the second text and providing the second text with a display manager of an operation system of the electronic device.

9. The method of claim 1, wherein the determining of at the least one display area as the conversion area comprises:
detecting a user input; and
determining at least one display area as the conversion area based on the user input.

10. The method of claim 9, wherein the user input comprises at least one of a C-type touch hover, a pen hover, a mouse pointer hover, a touch, a mouse click, an air gesture, and a pupil input.

11. The method of claim 9, wherein the user input comprises a preliminary input for determining the conversion area.

12. The method of claim 1, wherein the determining of the at least one display area as the conversion area comprises:
determining whether the at least one display area can be converted to a text; and
determining, if the at least one display area can be converted to a text, the at least one display area to the conversion area.

13. The method of claim 12, further comprising displaying whether the at least one display area can be converted to a text.

14. The method of claim 1, wherein the acquiring of the first text comprises:
determining whether an image is included in the conversion area; and
extracting, if the image is included in the conversion area, at least one first text through an optical character recognition (OCR) conversion of the image.

15. The method of claim 1, further comprising, while acquiring the first text, providing a visual effect representing that a text conversion is being performed.

16. The method of claim 1, further comprising converting a layout of the conversion area using a length of the second text, when a length of the first text and a length of the second text are different.

17. An electronic device comprising:
a display unit configured to display a screen including at least one display area; and
a processor configured to control to determine at least one of at least one display area included in the screen as a conversion area, to acquire a first text included in the conversion area, and to provide a second text corresponding to the first text.

18. The electronic device of claim 17, wherein the processor is configured to control to replace the first text with the second text and to display the second text in the display unit.

19. The electronic device of claim 17, wherein the second text comprises a text in which the first text is translated into a second language, and
wherein the second language comprises a language different from a first language of the first text.

20. The electronic device of claim 19, further comprising a communication unit configured to transmit and receive a signal to and from an external server,
wherein the second text comprises a text in which the first text is translated into the second language by a translation system of the external server.

21. The electronic device of claim 19, wherein the second text comprises a text in which the first text is translated into the second language by an internal translation system of the electronic device.

22. The electronic device of claim 19, wherein the second language comprises one of a system language of the electronic device and a language set by a user.

23. The electronic device of claim 17, wherein the processor is configured to acquire a first text included in the conversion area using a display manager of an operation system of the electronic device.

24. The electronic device of claim 17, wherein the processor is configured to replace the first text device with a second text using a display manager of an operation system of the electronic device.

25. The electronic device of claim 17, further comprising an input unit,
wherein the processor is configured to determine at least one display area in which a user input is detected as the conversion area through the input unit among at least one display area included in the screen.

26. The electronic device of claim 25, wherein the user input comprises at least one of a C-type touch hover, a pen hover, a mouse pointer hover, a touch, a mouse click, an air gesture, and a pupil input.

27. The electronic device of claim 25, wherein the user input comprises a preliminary input for determining the conversion area.

28. The electronic device of claim 25, wherein the input unit is configured to detect at least one of a hovering input and a touch input.

29. The electronic device of claim 17, wherein the processor is configured to extract at least one text included in the at least one display area.

30. The electronic device of claim 17, wherein the processor is configured to control to display whether the at least one display area can be converted to a text in the display unit.

31. The electronic device of claim 17, wherein the processor is configured to extract at least one first text through an optical character recognition (OCR) conversion of the image, when an image is included in the conversion area.

32. The electronic device of claim 17, wherein the processor is configured to control to display, while acquiring the first text, a visual effect representing that a text conversion is being performed.

33. The electronic device of claim 17, wherein the processor is configured to control to convert a layout of the conversion area using a length of the second text, when a length of the first text and a length of the second text are different.

34. A non-transitory computer readable recording medium on which a program to execute an operation of displaying a screen including at least one display area, an operation of determining at least one of the at least one display area as a conversion area, an operation of acquiring a first text included in the conversion area, and an operation of providing a second text corresponding to a first text.
